(19) United States
(12) Patent Application Publication
(10) Pub. No.: US 2005/0112326 A1
(43) Pub. Date: May 26, 2005

(54) Shaping method for producing shaped bodies with at least one surface that has self-cleaning properties, and shaped bodies produced according to this method

(75) Inventors: Edwin Nun, Billerbeck (DE); Markus Oles, Hattingen (DE); Arne Lang, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/506,993

(22) PCT Filed: Feb. 3, 2003
(86) PCT No.: PCT/EP03/01028

(30) Foreign Application Priority Data
Mar. 12, 2002 (DE) 102 10 666.5

(51) Int. Cl. B32B 1/00

(52) U.S. Cl. 428/143

(57) ABSTRACT

The invention relates to shaping processes for producing moldings with at least one surface which has self-cleaning properties and has elevations formed by microparticles, by thermal shaping of materials comprising organic compounds by means of a mold, and also to the resultant moldings. The process of the invention generates surfaces with self-cleaning properties by, prior to the thermal shaping, applying microparticles to the inner surfaces of the mold and then carrying out the molding process, in which the microparticles are pressed into and anchored into the surface of the molding, where this surface has not yet solidified. The process of the invention may be used in thermal shaping processes selected from blow molding, extrusion blow molding, extrusion stretch blow molding, injection blow molding, injection stretch blow molding, thermoforming, vacuum stretch forming, pressure stretch forming, and rotary thermoforming. The process is suitable for producing three-dimensional articles, such as bottles, housing parts, drums, and many other items. The process of the invention is very simple, since it makes use of existing equipment. The process of the invention gives access to self-cleaning surfaces which have particles with a fissured structure, without any need to apply an additional emboss layer or foreign-material carrier layer to the moldings.

The present invention relates to molding processes for producing moldings with at least one surface which has self-cleaning properties and has elevations formed by microparticles, by thermal shaping of materials comprising organic compounds by means of a mold and also to moldings thus produced.

Various processes for treating surfaces making the surfaces dirt- and water-repellent have been disclosed in surface technology. For example, it is known that if a surface is to be given good self-cleaning properties it has not only to be hydrophobic but to have a certain roughness. A suitable combination of structure and hydrophobic properties makes it possible for even small amounts of water set in motion on the surface to entrain adherent dirt particles and clean the surface (WO 96/04123; U.S. Pat. No. 3,354,022, C. Neinhuis, W. Barthlott, Annals of Botany 79. (1997), 667).

As early as 1982, A. A. Abramson described, in Chimia i Shisn russ. 11, 38, the roll-off of water droplets from hydrophobic surfaces, especially if they have structuring, even at extremely low inclinations, but there was no recognition there of self-cleaning properties.

The prior art of EP 0 933 388 requires an aspect ratio greater than 1 and surface energy of less than 20 mN/m for self-cleaning surfaces, the aspect ratio being defined as the quotient calculated by dividing the average height of the structure by its average width. The abovementioned criteria are to be found in the natural world, for example in the lotus leaf. The 30′ surface of the plant, formed from a hydrophobic waxy material, has elevations, the distance between which is a few μm. Water droplets essentially contact only the peaks of the elevations. There are many descriptions in the literature of water-repellent surfaces of this type. An example here is an article in Langmuir 2000, 16, 5754, by Masashi Miwa et al., stating that contact angle and roll-off angle increase with increased structuring of artificial surfaces formed from Boehmite, applied to a spin-coated layer and then calcined.

Swiss Patent 268258 describes a process in which structured surfaces are generated by applying powders, such as kaolin, talc, clay, or silica gel. The powders are secured to the surface by way of oils and resins based on organosilicon compounds.

It is known that hydrophobic materials, such as perfluorinated polymers, can be used to produce hydrophobic surfaces. DE 197 15 906 A1 describes the use of perfluorinated polymers, such as polytetrafluoroethylene, or copolymers made from polytetrafluoroethylene with perfluorinated alkyl vinyl ethers, to generate hydrophobic surfaces which have structuring and have low adhesion to snow and ice. JP 11171592 describes a water-repellent product and its production, the dirt-repellent surface being produced by applying, to the surface to be treated, a film which comprises fine particles made from metal oxide and comprises the hydrolyzate of a metal alkoxide and, respectively, of a metal chelate. To secure the film, the substrate to which the film has been applied has to be sintered at temperatures above 400° C. This process is therefore useful only for substrates which can be heated to temperatures above 400° C.

The processes conventionally used hitherto for producing self-cleaning surfaces are complicated and in many cases have only limited usefulness. For example, embossing techniques are an inflexible method of applying structures to three-dimensional bodies of varying shapes. There is still currently no suitable technology for generating flat coating films of large surface area. A disadvantage of processes in which structure-forming particles are applied to surfaces by means of a carrier—e.g. an adhesive—is that the resultant surfaces are composed of a great variety of combinations of materials which, for example, have different coefficients of thermal expansion, the possible result being damage to the surface.

It was therefore an object of the present invention to provide a process for producing self-cleaning surfaces on three-dimensional moldings. The maximum simplicity of technology should be used here, and the self-cleaning surfaces should be durable.

Surprisingly, it has been found that when hydrophobic, nanostructured particles are applied to the inner mold surfaces of molds for thermal shaping, and then molding a molding by using this mold, the particles can be firmly anchored to the surface of the molding.

The present invention therefore provides a shaping process for producing moldings with at least one surface which has self-cleaning properties and has elevations formed by microparticles, by thermal shaping of materials comprising organic compounds by means of a mold, characterized in that, prior to the thermal shaping process, microparticles are applied to the inner surfaces of the mold, and the shaping process is then carried out, in which the microparticles are pressed into and anchored into the surface, which has not yet solidified, of the molding.

The present invention also provides moldings with at least one surface which has self-cleaning properties and has surface structures with elevations, produced by the process of the invention.

An advantage of the process of the invention is that it can utilize existing equipment for producing moldings by thermal shaping. The usual method of producing moldings of this type is that the material to be processed is softened or melted and a mold is used to mold this material. The process of the invention utilizes this process insofar as, prior to the actual shaping process, microparticles are applied to the mold, and are transferred to the molding during the shaping process, by pressing the particles into the softened or molten surface of the molding. This simple: method gives access to moldings with self-cleaning surfaces which have particles with a fissured structure, without any need to apply an additional emboss layer or foreign-material carrier layer to the moldings.

An advantage of the moldings of the invention is that structure-forming particles are not secured by a carrier material, thus avoiding an unreasonably high number of combinations of materials and the adverse properties associated therewith.

The process of the invention gives access to self-cleaning moldings in which the self-cleaning properties are not achieved by virtue of any additional application of material for securing the particles, or by virtue of any additional chemical process.

Another advantage of the process of the invention is that surfaces susceptible to scratching are not damaged by subsequent mechanical application of a carrier layer and/or of particles.

A circumstance which proves to be very particularly advantageous is that any desired surfaces which can be produced by thermal shaping processes can be rendered self-cleaning. Another advantage is the demoldability of fine-structured moldings. This cannot always be reliably provided by structured molds.

The invention is described below by way of example, but is not limited to these embodiments.

A feature of the shaping process of the invention for producing moldings with at least one surface which has self-cleaning properties and has elevations formed by microparticles, by thermal shaping of materials comprising organic-compounds, by means of a mold, is that, prior to the thermal shaping, microparticles are applied to the inner surfaces of the mold, and then the shaping process is carried out, in which the microparticles are at least to some extent pressed into and anchored into the surface, which has not yet solidified, of the molding. The mold is preferably a mold which is usually used for producing conventional moldings. These conventional molds may, for example, be composed of two parts, the cavity and the core. In the process of the invention, the microparticles may be applied to the cavity (female mold) and/or to the core (male mold). During the shaping process, the microparticles are at least to some extent pressed into the molding composition, and are firmly held by the molding composition when it solidifies, and are thus anchored, giving particularly stable anchoring if the microparticles used have a fine structure on the surface, since, the fine structure is to some extent filled by the molding composition and many anchoring points are present once the composition has solidified. The surface produced by the process of the invention with self-cleaning properties and microparticles on the surface which form elevations may have been designed so that the surface exclusively has microparticles, or almost exclusively has microparticles, or else has microparticles whose separation from one another is from 0 to 10 particle diameters, in particular from 0 to 3 particle diameters.

The process of the invention can use a very wide variety of known thermal shaping processes in which the molding composition is softened or melted by introducing thermal energy and then a mold is used to mold this composition. The thermal shaping process is preferably one selected from blow molding, extrusion blow molding, extrusion stretch blow molding, injection blow molding, injection stretch blow molding, thermoforming, vacuum stretch forming, pressure stretch forming, and rotary thermoforming. The nature of the actual conduct of these processes is known per se. Examples of descriptions of these thermal shaping processes may be found in: Kunststoff Handbuch 1, Die Kunststoffe; Chemie, Physik, Technologie [Plastics Handbook 1, The Plastics; Chemistry, Physics, Technology], Bodo Carlowitz (Editor), Hanser Verlag Munich 1990, or in Hans Batzer, Polymere Werekstoffe [Polymeric materials], Georg Thieme Verlag Stuttgart—New York, 1984, and also in the references cited within these references. They also give descriptions of equipment, starting materials, and process parameters for the conduct of the thermal shaping processes, and these need not therefore be described here in any further detail.

The material comprising organic compounds and used as molding composition may comprise any of the materials which comprise polymer blends or polymers suitable for thermal shaping. The material comprising organic compounds and used in the process of the invention is preferably a material comprising a natural rubber or a synthetic rubber, or a vulcanized rubber, or, as a mixture or individually, and as homopolymer or copolymer, polynorbornene, or acrylonitrile-butadiene-styrene terpolymers (ABS), or poly(4-methyl-11-pentene), or polyisobutene, or poly(vinylidene fluoride), or polyalkylene terephthalates, in particular polyethylene terephthalate or polybutylene terephthalate (PET or PBT), or polyacrylonitrile, or polyether sulfones, or polyesters, or polystyrenes, or cyclic polyalkenes, or aliphatic linear or branched polyalkenes, or polypropylenes, or polyethylenes, or polyvinyl chloride, or polyamides, or poly(meth)acrylates, or polycarbonates, in a polymer. In this context, the skilled worker is aware that certain of the abovementioned materials can be used only for certain shaping processes. From the thermoplastic polymers group, those particularly suitable for blow molding are PVC and polypropylene, and those particularly suitable for extrusion blow molding, extrusion stretch blow molding, injection blow molding, and injection stretch blow molding are PET, polycarbonates, e.g. Makrolone® grades, and polypropylenes, and those particularly suitable for thermoforming, vacuum stretch forming, pressure stretch forming, and rotary thermoforming are polypropylene ABS, and PVC.

The impression process involved in the process of the invention is preferably conducted so that at least some of the particles, preferably at least 50% of the particles, are pressed into the softened or molten surface of the molding to the extent of not more than 90% of their diameter, preferably using from 10 to 70%, with preference using from 20 to 50%, and very particularly preferably using from 30 to 40%, of their average particle diameter. The surface of the molding into which the microparticles are pressed and anchored, where this surface has not yet solidified, may be the surface of a melt of a material to be molded, or the softened surface of a material to be molded.

The microparticles which are pressed into the surface of the molding in the process of the invention are applied, prior to the process of impression via shaping, to the surface of the mold, or to at least one portion of a mold. Depending on the thermal shaping process used, and on the mold used, it can be advantageous for microparticles to be applied only to those surfaces of the mold which, during shaping of the subsequent molding, e.g. a vessel or a bottle, come into contact with an external and/or an internal surface of the molding. This permits the production of articles which have surfaces with self-cleaning properties either on their inner sides or on their outer sides, or on the inner and outer sides. In particular during injection stretch blow molding, which is used for example to produce moldings with rotational symmetry (hollow articles), e.g. to produce bottles, it can be advantageous to apply microparticles to the mold core used to produce the inside of a parison. Despite subsequent blowing of the parison, the final product has inner surfaces with elevations, and these have self-cleaning properties.

The preferred method of application is spraying. Application of the microparticles to the mold is advantageous particularly because the micropowder inhibits adhesion of the material of the molding to the mold once the molding procedure has ended, since there is little, or no, contact of the material itself with the mold, because the microparticles are applied very densely to the mold to achieve the preferred separations of the elevations.

Examples of methods of spray-application of the microparticles to the mold are spray-application of microparticle-powder-containing aerosols or dispersions which, besides the microparticles, comprise a propellant or a preferably highly volatile solvent, preference being given to spray-application from suspensions. The solvent preferably present in the suspensions used is an alcohol, in particular ethanol or isopropanol, ketones, e.g. acetone or methyl ethyl ketone, ethers, e.g. diisopropyl ether, or else hydrocarbons, such as cyclohexane. The suspensions particularly preferably comprise alcohols. It can be advantageous for the suspension to comprise from 0.1 to 10% by weight, preferably from 0.25 to 7.5% by weight, and very particularly preferably from 0.5 to 5% by weight, of microparticles, based on the total weight of the suspension. In particular in the case of spray-application of a dispersion, it can be advantageous for the mold to have a mold surface temperature of from 30 to 150° C. Depending on the molding to be produced or on the material used therefor, however, the temperature of the mold may also be any temperature in the range mentioned, irrespective of the microparticle powder or the application of the microparticle powder.

The microparticles used in the process of the invention are preferably those which comprise at least one material selected from silicates, minerals, metal oxides, metal powders, silicas, pigments, and polymers. It is preferable to use microparticles whose diameter is from 0.02 to 100 μm, particularly preferably from 0.1 to 50. μm, and very particularly preferably from 0.1 to 30 μm. It is also possible to use microparticles with diameters below 500 nm. However, other suitable microparticles are those accreted from primary particles to give agglomerates or aggregates whose size is from 0.2 to 100 μm.

The microparticles used, in particular the particles whose surface has an irregular fine structure in the nanometer range, are particles which comprise at least one compound selected from fumed silica, precipitated silicas, aluminum oxide, mixed oxides, doped silicates, titanium dioxides, and pulverulent polymers. Preferred particles whose surface has an irregular fine structure in the nanometer range have, within this fine structure, elevations whose aspect ratio is greater than 1, particularly preferably greater than 1.5, and very particularly preferably greater than 2.5. The aspect ratio is in turn defined as the quotient calculated by dividing the maximum height of the elevation by its maximum width.

The microparticles preferably have hydrophobic properties, which may be attributable to the properties of the materials present on the surfaces of the particles, or else be obtained by treating the particles with a suitable compound. The particles may be provided with hydrophobic properties prior to or after the process of pressing into the surface.

For the hydrophobicization of the microparticles prior to or after the process of pressing (anchoring) into the surface of the molding, these may be treated with a compound suitable for hydrophobicization, e.g. one selected from the alkylsilanes, the fluoroalkylsilanes, and the disilazanes, for example those supplied as Dynasylan by Degussa AG.

The microparticles whose use is preferred are described in more detail below. The particles used may come from a variety of sectors. For example, they may be titanium dioxides, doped silicates, minerals, metal oxides, aluminum oxide, silicas, fumed silicates, Aerosils® or pulverulent polymers, e.g. spray-dried and agglomerated emulsions, or cryogenically milled PTFE. Particularly suitable particle systems are hydrophobicized fumed silicas, known as Aerosils. To generate the self-cleaning surfaces, hydrophobic properties are needed alongside the structure. The particles used may themselves be hydrophobic, for example PTFE. The particles may have been provided with hydrophobic properties, for example Aerosil VPR 411®, or Aerosil R. 8200®. However, they may also be hydrophobicized subsequently. It is unimportant here whether the particles are hydrophobicized prior to application or after application. Examples of these particles which have to be hydrophobicized are Aeroperl P 90/30®, Sipernat silica 350, Aluminum oxide C®, Zirconium silicate, vanadium-doped or. VP Aeroperl P 25/20®. In the case of the latter, it is advantageous for the hydrophobicization to take place by treatment with perfluoroalkylsilane compounds followed by heat-conditioning.

The process of the invention can produce moldings with at least one surface which has self-cleaning properties and has surface structures with elevations. A feature of these moldings with at least one surface which has self-cleaning properties is that the surface has at least one firmly anchored layer of microparticles which form elevations. The presence of elevations on at least portions of the surface of the moldings, in combination with hydrophobic properties, ensures that these regions of the surface are difficult to wet and therefore have self-cleaning properties. The securely anchored layer of microparticles is obtained by applying microparticles in the form of a layer to the mold prior to the shaping process, and then using this mold for molding. During the shaping process, the microparticles are pressed at least to some extent into the molding composition, and are securely held and therefore anchored by the molding composition when it solidifies, giving particularly stable anchoring if the microparticles used have a fine structure in the surface, since the fine structure is to some extent filled by the molding composition, and many anchoring points are present once the molding composition has solidified. For the purposes of the present invention, a layer of microparticles is a collection of microparticles forming elevations on the surface. The design of the layer may be such that the surface exclusively has microparticles, or almost exclusively has microparticles, or has microparticles whose separation from one another is from 0 to 10 particle diameters, in particulars from 0 to 3 particle diameters.

The surfaces of the moldings with self-cleaning properties preferably have at least one layer with elevations with an average height of from 20 nm to 25 μm and with an average separation of from 20 nm to 25 μm, preferably with an average height of from 50 nm to 10 μm and/or with an average separation of from 50 nm to 10 μm, and very particularly preferably with an average height of from 50 mm to 4 μm and/or with an average separation of from 50 nm to 4 μm. The moldings of the invention very particularly preferably have surfaces with elevations with an average height of from 0.25 to 1 μm and with an average separation of from 0.25 to 1 μm. For the purposes of the present invention, the average separation of the elevations is the separation between the highest elevation of one elevation and the nearest highest elevation. If the elevation is a cone, the peak of the cone is the highest elevation of the elevation. If the elevation is a rectangular parallelepiped, the uppermost surface of the parallelepiped is the highest elevation of the elevation.

The wetting of bodies, and therefore the self-cleaning property, can be described via the angle of contact made by a water droplet with the surface. An angle of contact of 0 degree here means complete wetting of the surface. The static angle of contact is generally measured using equipment in which the angle of contact is determined optically. Static contact angles below 125° C. are usually measured on smooth hydrophobic surfaces. The present moldings with self-cleaning surfaces have static contact angles which are preferably above 130°, with preference above 140°, and very particularly preferably above 145°. In addition, it has been found that a surface has good self-cleaning properties only when it exhibits a difference of not more than 10° between advancing and receding angle, and for this reason surfaces of the invention preferably have a difference of less than 10°, preferably less than 5°, and very particularly preferably less than 4°, between advancing and receding angle. To determine the advancing angle, a water droplet is placed on the surface by means of a cannula, and the droplet is enlarged on the surface by adding water through the cannula. During enlargement, the margin of the droplet glides over the surface, and the contact angle determined is the advancing angle. The receding angle is measured on the same droplet, but water is removed from the droplet through the cannula, and the contact angle is measured during reduction of the size of the droplet. The difference between the two angles is termed hysteresis. The smaller the difference, the smaller the interaction of the water droplet with the surface of the substrate, and therefore the better the lotus effect.

The aspect ratio for the elevations of the surfaces of the invention with self-cleaning properties is preferably greater than 0.15. The elevations formed by the particles themselves preferably have an aspect ratio of from 0.3 to 0.9, particularly preferably from 0.5 to 0:8. The aspect ratio is defined here as the quotient calculated by dividing the maximum height of the structure of the elevations by its maximum width.

In the moldings of the invention with surfaces which have self-cleaning properties and have surface structures with elevations, the surfaces are preferably synthetic polymer surfaces into which particles have been directly incorporated or directly anchored, and have not been bonded via carrier systems or the like.

The particles are bonded or anchored to the surface in that the particles are pressed into the molten or softened material of the molding or of the molding composition during process. An advantageous method of achieving the aspect ratios mentioned is that at least some of the particles, preferably more than 50%, more preferably more than 75% of the particles, are preferably pressed into the surface of the molding only to the extent of 90% of their diameter. The surface therefore preferably has particles which have been anchored in the surface using from 10 to 90%, preferably from 20 to 50%, and very particularly preferably from 30 to 40%, of their average particle diameter, and parts of whose inherently fissured surface therefore still protrude from the moldings. This method ensures that the elevations formed by the particles themselves have a sufficiently large aspect ratio, preferably at least 0.15. This method also ensures a very lasting bond, between the securely bonded particles and the surface of the molding. The aspect ratio here is defined as the ratio of maximum height of the elevations to their maximum width. According to this definition, the aspect ratio for a particle assumed to be ideally spherical and projecting to an extent of 70% from the surface of the molding is 0.7. It should be expressly pointed out that the particles of the invention do not have to be of spherical shape.

The microparticles securely bonded to the surface and forming the elevations on the surface of the moldings have preferably been selected from silicates, minerals, metal oxides, metal powders, silicas, pigments, and polymers, very particularly preferably from fumed silicas, precipitated silicas, aluminum oxide, mixed oxides, doped silicates, titanium dioxides, and pulverulent polymers.

Preferred microparticles have a diameter of from 0.02 to 100 μm, particularly preferably from 0.1 to 50 μm, and very particularly preferably from 0.1 to 30 μm. However, suitable microparticles may also have a diameter below 500 nm, or be formed by accretion of primary particles to give agglomerates or aggregates with a size of from 0.2 to 100 μm.

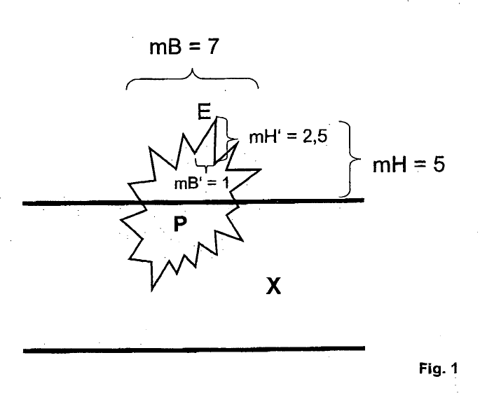

Particularly preferred microparticles which form the elevations of the structured surface of the inventive molding are those whose surface has an irregular, slightly fissured fine structure in the nanometer range. These microparticles with the irregular, slightly fissured fine structure preferably have elevations with an aspect ratio greater than 1 in the fine structures, particularly preferably greater than 1.5. The aspect ratio is in turn defined as the quotient calculated by dividing the maximum height of the elevation by its maximum width. FIG. 1 gives an illustrative diagram of the difference between the elevations formed by the particles and the elevations formed by the fine structure. The figure shows the surface of a thermoformed molding X, which has particles P (only one particle being depicted in order to simplify the presentation). The elevation formed by the particle itself has an aspect ratio of about 0.71, this being the quotient calculated by dividing the maximum height mH of the particle, which is 5, since only that portion of the particle which protrudes from the surface of the molding X contributes to the elevation, by its maximum width mB, which in turn is 7. A selected elevation of the elevations E present on the particles by virtue of their fine structure has an aspect ratio of 2.5, this being the quotient calculated by dividing the maximum height mH of the elevation, which is 2.5, by its maximum width mB, which in turn is 1.

Preferred microparticles whose surface has an irregular fine structure in the nanometer range are those particles which comprise at least one compound selected from fumed silica, precipitated silicas, aluminum oxide, mixed oxides, doped silicates, titanium dioxides, and pulverulent polymers.

It can be advantageous for the microparticles to have hydrophobic properties, which may be attributable to the properties of the material present on the surfaces of the particles, or else may be obtained by treating the particles with a suitable compound. The microparticles may be provided with hydrophobic properties prior to or after application or bonding to the surface of the molding. To hydrophobicize the particles prior to or after application to the surface, they may be treated with a compound suitable for hydrophobicization, e.g. selected from the group of the alkylsilanes, the fluoroalkylsilanes, and the disilazanes.

Particularly preferred microparticles are described in more detail below. The particles may be derived from various fields. For example, they may be silicates doped silicates, minerals, metal oxides, aluminum oxide, silicas, or titanium dioxides, Aerosils®, or pulverulent polymers, e.g. spray-dried and agglomerated emulsions, or cryogenically milled PTFE. Particularly suitable particle systems are hydrophobicized fumed silicas, known as Aerosil® grades. To generate the self-cleaning surfaces, hydrophobic properties are needed along side the structure. The particles used may themselves be hydrophobic, for example pulverulent polytetrafluoroethylene(PTFE). The particles may have been given hydrophobic properties, for example Aerosil VPR 411® or Aerosil R 8200®. However, they may also be hydrophobicized subsequently. It is unimportant here whether the particles are hydrophobicized prior to application or after application. Examples of these particles which have to be hydrophobicized are Aeroperl 90/30®, Sipernat silica 350®, Aluminum oxide C®, Zirconium silicate, vanadium-doped or VP Aeroperl 25/20®. In the case of the latter, it is advantageous for the hydrophobicization to take place by treatment with perfluoroalkylsilane compounds followed by heat-conditioning.

The moldings may have the elevations on all surfaces or only on certain surfaces, or on subregions of these. The moldings of the invention preferably have the elevations on all surfaces or on all inner and/or outer surfaces.

The material of the moldings may preferably comprise polymers or polymer blends based on polycarbonates, on polyoxymethylenes, on poly(meth)acrylates, on polyamides, on polyvinyl chloride (PVC), on polyethylenes, on polypropylenes, on polystyrenes, on polyesters, on polyether sulfones, on aliphatic linear or branched polyalkenes, on cyclic polyalkenes, on polacrylonitrile, or on polyalkylene terephthalates, or else a mixture of these, or copolymers. The material of the moldings is particularly preferably a material selected from poly(vinylidene fluoride), or is another polymer selected from polyethylene, polypropylene, polyisobutene, poly(4-methyl-1-pentene), and polynorbornene, in the form of homo- or copolymer. The material for the surface of the molding is very particularly preferably a material comprising a natural rubber, or a synthetic rubber, or a vulcanized rubber, or poly(vinylidene fluoride), or polybutylene terephthalate, or polyethylene terephthalate, or acrylonitrile-butadiene-styrene terpolymers (ABS), polyesters, polystyrenes, polymethyl methacrylates, polypropylene, or polyethylene.

The process of the invention gives access to three-dimensional moldings with a surface which at least in part has self-cleaning properties and has surface structures with elevations. The moldings may have any desired shape which can be produced by the known processes of thermal shaping. These moldings may in particular be vessels for receiving liquids or pastes. These moldings may in particular be those selected from vessels, lampshades, bottles, automotive tires, other tires, buckets, storage vessels, drums, trays, measuring beakers, funnels, tanks, and housing parts.

The process of the invention is described using FIG. 1, but there is no intention that the invention be restricted thereto. FIG. 1 is a diagram of the surface of a thermoformed molding X, where the surface comprises particles P. (To simplify the presentation, only one particle is depicted). The elevation formed by the particle itself has an aspect ratio of about 0.71, this being the quotient calculated by dividing the maximum height mH of the particle, which is 5, since only that portion of the particle which protrudes from the surface of the molding X contributes to the elevation, by its maximum width mB, which in turn is 7. A selected elevation of the elevations E present on the particles by virtue of their fine structure has an aspect ratio of 2.5, this being the quotient calculated by dividing the maximum height mH′ of the elevation, which is 2.5, by its maximum width mB′, which in turn is 1.

The process of the invention is described using the examples below, but there is no intention that the invention be restricted to this embodiment.

### EXAMPLE 1

A suspension of Aerosil R8200® (1% by weight in ethanol) is applied to a thermoforming mold in a thermoforming machine (725, C. R. Carke & Co.), and the solvent (ethanol) is then evaporated. A molded sheet (0.5 mm) made from Vinnolit S 3257, a PVC with K value 57 is applied to the mold thus prepared, and is heated to the usual processing temperature for PVC. A vacuum is applied to thermoform the softened molded sheet. After adequate cooling, the vacuum pump is switched over to blowing, and the resultant molding is separated from the mold. This gives a molding which comprises microparticles anchored within the surface of the molding.

The roll-off angle for a water droplet from the resultant surface of the molding is determined by applying a droplet to the surface and progressively increasing the inclination of the molding to determine the angle at which the droplet rolls off from the surface. For a water droplet of size 40 μl the roll-off angle obtained is 7.7°. An advancing angle of about 152° and a receding angle of 149.9° are also determined. These values show that the process of the invention can produce moldings which have self-cleaning surfaces.

1. A process for producing a molding comprising:
accreting primary particles to form microparticles,
wherein said microparticles have hydrophobic properties and said microparticles comprise agglomerates or aggregates of from 0.2 to 100 μm,
applying the microparticles to the inner surfaces of a mold,
molding a molding composition
wherein the molding composition comprises at least one material comprising organic compounds and said molding composition is in softened or molten form, and
thermally shaping the molding composition in the mold, and
solidifying the molding composition to obtain the molding,
wherein not more than 90% of the diameter of at least 50% of the microparticles are impressed into the surface of the molding which has not yet solidified,
said microparticles are firmly held by the molding to anchor said microparticles into the molding after the molding is solidified,
said molding has elevations formed by the microparticles and
said molding has at least one surface having self-cleaning properties.

2. The process as claimed in claim 1, wherein
said thermally shaping is at least one process selected from the group consisting of blow molding, extrusion blow molding, extrusion stretch blow molding, injection blow molding, injection stretch blow molding, thermoforming, vacuum stretch forming, pressure stretch forming, and rotary thermoforming.

3. The process as claimed in claim 1 wherein said applying the microparticles is
spraying the microparticles to the inner surfaces of the mold.

4. The process as claimed in claim 3, wherein said applying the microparticles is
applying a suspension, which comprises microparticles and at least one solvent, into the inner surfaces of the mold and then
evaporating the solvent.

5. The process as claimed in claim 3, wherein said applying the microparticles is applying an aerosol, which comprises microparticles and at least one propellent gas, to the inner surfaces of the mold.

6. The process as claimed in claim 1, wherein
the microparticles are selected from the group consisting of particles of silicates, minerals, metal oxides, metal powders, silicas, pigments, polymers and mixtures thereof.

7. The process as claimed in claim 1 wherein the microparticles are hydrophobicized fumed silicas.

8. The process as claimed in claim 1, wherein
said at least one material comprising organic compounds comprises at least one material selected from the group consisting of a natural rubber, or a synthetic rubber, a vulcanized rubber, polynorbornene, poly-4-methyl-1-pentene, polyisobutene, acrylonitrile-butadiene-styrene terpolymers, polyvinylidene fluoride, polyalkylene terephthalates, polyacrylonitrile, polyether sulfones, polyesters, polystyrenes, cyclic polyalkenes, aliphatic linear branched polyalkenes, polypropylenes, polyethylenes, polyvinyl chloride, polyamides, polymethacrylates, polyacrylates, polycarbonates, a copolymer comprising at least one repeat unit selected from the group consisting of polynorbornene, poly-4-methyl-1-pentene, polyisobutene, acrylonitrile-butadiene-styrene terpolymers, polyvinylidene fluoride, polyalkylene terephthalates, polyacrylonitrile, polyether sulfones, polyesters, polystyrenes, cyclic polyalkenes, aliphatic linear or branched polyalkenes, polypropylenes, polyethylenes, polyvinyl chloride, polyamides, polymethacrylates, polyacrylates and polycarbonates,
and mixtures thereof.

9. The process as claimed in claim 1, wherein
the microparticles are pressed into the surface of the molding which has not yet solidified,
and the surface of the molding which has not yet solidified is the surface of the molding composition in the molten form.

10. The process as claimed in claim 1, wherein
the microparticles are pressed into the surface of the molding which has not yet solidified,
and the surface of the molding which has not yet solidified is the surface of the molding composition in the softened form.

11. A molding produced by a process as claimed in claim 1, wherein said molding has at least one surface having self-cleaning properties and surface structures with elevations.

12. The molding as claimed in claim 11, wherein
the elevations have an average height of from 20 nm to 25 μm and an average separation of from 20 nm to 25 μm.

13. The molding as claimed in claim 12, the elevations have an average height of from 50 nm to 4 μm and/or an average separation of from 50 nm to 4/m.

14. The molding as claimed in claim 11, wherein
the molding comprises microparticles and the microparticles are selected from the group consisting particles of silicates, minerals, metal oxides, metal powders, silicas, pigments, polymers and mixtures thereof.

15. The molding as claimed in claim 11, wherein
the molding comprises impressed particles and the impressed particles are anchored with from 10 to 90% of their average particle diameter within the surface of the molding.

16. The molding as claimed in claim 11, wherein
the molding is a three-dimensional article selected from the group consisting of vessels, lampshades, buckets, bottles, tires, automotive tires, storage vessels, drums, dishes, measuring beakers, funnels, tanks, splash guard components, discharge aids, and housing parts.
